(19) United States
(12) Patent Application Publication
(10) Pub. No.: US 2022/0229874 A1
(43) Pub. Date: Jul. 21, 2022

(54) Web-Based Tracing System

(71) Applicant: Edwin Lord Bukenya Muwonge, Glendale, WI (US)

(72) Inventor: Edwin Lord Bukenya Muwonge, Glendale, WI (US)

(21) Appl. No.: 17/577,338

(22) Filed: Jan. 17, 2022

Related U.S. Application Data
(60) Provisional application No. 63/137,796, filed on Jan. 15, 2021.

(51) Int. Cl. G06F 16/951; G06F 16/9535; G06F 16/9536; G06F 16/9538; G06F 16/22

(52) U.S. Cl. CPC G06F 16/951; G06F 16/9535; G06F 16/2246; G06F 16/9538; G06F 16/9536

(57) ABSTRACT

A web-based tracing system comprises an account creation module for creating an account comprising genealogical data with a unique identifier for a user in a genealogy system; a genealogy module for generating family trees of accounts in the genealogy system with a parent-descendent hierarchy based on the genealogical data and the user directions; a group moderation module for managing groups of users of the genealogy system for communication within the genealogy system; a communication module for dispensing communication services comprising textual and audiovisual chats and sharing of files between individual users of the genealogy system and among users in a group in the genealogy system; and a notification module for notifying users with accounts in a family tree of additions of accounts to the family tree or flagging of an account as belonging to a newborn or a deceased person by a user in the family tree after verification by administrative personnel of the genealogy system.

### CROSS-REFERENCE TO RELATED APPLICATIONS

This application claims priority to and the benefit of the provisional patent application titled “Web-based Genealogy Tracing With Social and Commercial Networking Services”, application No. 63/137,796, filed in the United States Patent and Trademark Office on Jan. 15, 2021. The specification of the above referenced patent application is incorporated herein by reference in its entirety.

### BACKGROUND

The system disclosed herein, in general, relates to genealogy tracing. More particularly, the system disclosed herein relates to a web-based genealogy tracing with social and commercial networking services. Individuals often find it difficult to know who their relatives are. This may make it near impossible for the individual to trace his lineage. Due to this, the individual may feel lonely. The individual may want to be able to talk to these relatives and know their whereabouts. The individual may also want to know if the relative is alive or dead as well as if a newborn had added in the Lineage. Therefore, there is a long felt yet unresolved need for a system that helps the individual to look for the individual's ancestors, siblings, and descendants in the present and in the generations to come.

### SUMMARY OF THE INVENTION

This summary is provided to introduce a selection of concepts in a simplified form that are further disclosed in the detailed description of the invention. This summary is not intended to determine the scope of the claimed subject matter.

The system disclosed herein addresses the above recited need for a system that helps the individual to look for the individual's ancestors, siblings, and descendants in the present and in the generations to come. The system disclosed herein relates to a web-based tracing system for tracing genealogy. The system also provides social and commercial networking services. The web-based tracing system comprises an account creation module for creating an account comprising genealogical data with a unique identifier for a user in a genealogy system. The web-based tracing system further comprises a genealogy module for generating family trees of accounts in the genealogy system with a parent-descendent hierarchy based on the genealogical data and the user directions. The web-based tracing system further comprises a group moderation module for managing groups of users of the genealogy system for communication within the genealogy system. The web-based tracing system further comprises a communication module for dispensing communication services comprising textual and audiovisual chats and sharing of files between individual users of the genealogy system and among users in a group in the genealogy system. The web-based tracing system further comprises a notification module for notifying users with accounts in a family tree of additions of accounts to the family tree or flagging of an account as belonging to a newborn or a deceased person by a user in the family tree after verification by administrative personnel of the genealogy system.

The web-based tracing system further comprises an advertisement module for dispensing advertisement services comprising posting and reacting to advertisements for goods and services in the genealogy system by users of the genealogy system. The web-based tracing system further comprises a commerce module for handling one-time and recurring monetary transactions and storing and auditing financial and transactional information. The web-based tracing system further comprises a security module for ensuring security of information, communication, and transactions in the genealogy system including encryption of data. The web-based tracing system further comprises a publishing module for publishing reports and summaries comprising user information, family tree graphs, communication reports, and financial reports derived from data in the genealogy system. The web-based tracing system further comprises an administration module for administering the genealogy system.

### BRIEF DESCRIPTION OF THE DRAWINGS

The foregoing summary, as well as the following detailed description of the invention, is better understood when read in conjunction with the appended drawings. For illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 illustrates a web-based tracing system for tracing genealogy and for providing social and commercial networking services.

FIG. 2 illustrates a context diagram for the web-based genealogy tracing and networking system.

FIGS. 3A-3C illustrate a data flow diagram of the web-based genealogy tracing and networking system.

FIGS. 4A-4B illustrate an entity relation diagram of the web-based genealogy tracing and networking system.

FIG. 5 exemplarily illustrates a computer implemented method for web-based tracing.

### DETAILED DESCRIPTION OF THE INVENTION

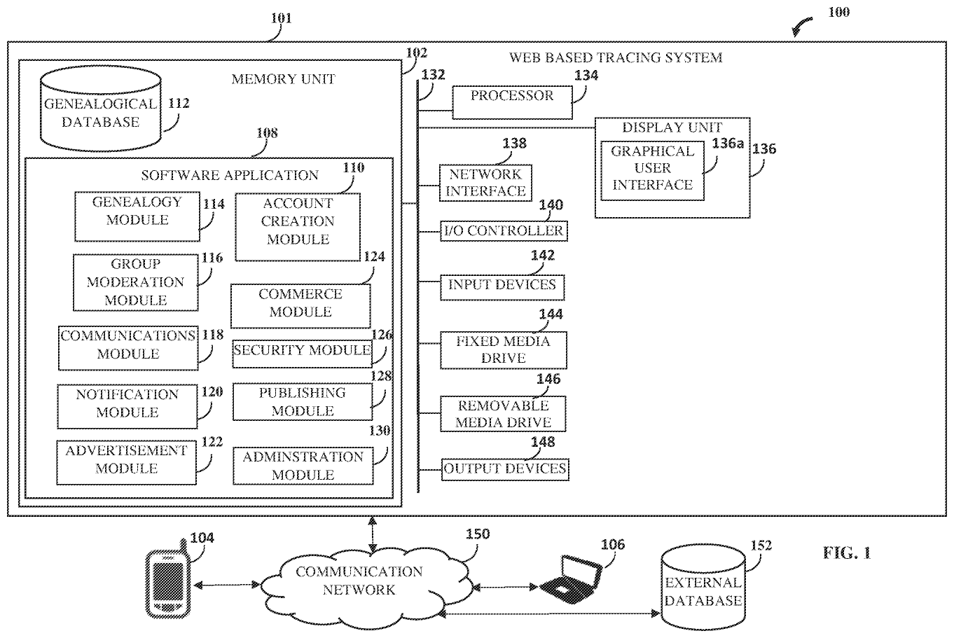

FIG. 1 illustrates a web-based tracing system 100 for tracing genealogy and for providing social and commercial networking services. The web-based tracing system comprises an online accessible software application 108 that is used to plot hierarchical lineage of people with respect to their families and relatives. The software application 108 helps a person to look for his ancestors and descendants as well as siblings and other relatives. The software application 108 enables these related people to communicate with each other through messages and other posts. Related people can post information to all other people on a platform provided by the web-based tracing system 100, for example in the form of advertisements to boost their businesses.

The ability of related people to share information with other people in the world enables the software application 108 to generate revenue through boosting this information (advertisements). Users shall register themselves as well as other relatives and this will increase the audience. The users may register themselves and their relatives through smartphones 104 and computers 106. The functionalities of the software application 108 comprise (a) the ability to plot the lineage of the families, (b) ability to state the ancestors, siblings, descendants, and relatives of people, and (c) providing the platform to enable the people to communicate with one another. Compared to other systems that are similar, the web-based tracing system 100 provides social and commercial networking services enabling the web-based tracing system 100 to function as an online social media platform. Compared to other systems that are similar, and that have similar functions like communication and advertisement, the web-based tracing system 100 differs by bringing the ability for one to look for and know their blood lineage and their relatives. Characteristics of the users of the web-based tracing system 100 disclosed herein are as follows: The users are people that have access to smartphones 104 and computers 106, have an email address and use the internet, know how to read and write.

The web-based tracing system 100 comprises an account creation module 110 for creating an account comprising genealogical data with a unique identifier for a user in a genealogy system. The genealogical data with a unique identifier are stored in a genealogical database 112, as shown in FIG. 1. The account is assigned as a root node in the genealogy system based on user direction where the user does not attach the account to a pre-existing family tree in the genealogy system as an ancestor node or a descendant node. An attempt to create an account with a unique identifier that is already present in the system is redirected to the account associated with the unique identifier. A subsequent account created by an existing account is assigned a pending status till the subsequent account is redirected to through an attempt to create a new account with the unique identifier associated with the subsequent account. In an embodiment, some users do not have an email address (the unique Identifier), this will force an individual to create an email address for that individual that is only known by him (the node creator), this can create a possibility for data duplication and inconsistencies in a condition where different people know different emails for the same person. It is difficult to remove a person that has descendants without losing them all.

The web-based tracing system 100 further comprises a genealogy module 114 for generating family trees of accounts in the genealogy system with a parent-descendent hierarchy based on the genealogical data and the user directions. The family trees and all accounts in the genealogical system are visible and can be searched for by a user with an account in the genealogy system. An account in the genealogy system can be a part of multiple family trees.

The web-based tracing system 100 further comprises a group moderation module 116 for managing groups of users of the genealogy system for communication within the genealogy system. Any user of the genealogy system may create a group and add other users to the group based on an acceptance of the addition by the other users. Every family tree has a group comprising the accounts in the family tree for communication. Communication within a group is visible only to users who are a part of the group. A group has group characteristics comprising a name, a picture, and a description that can be edited by users who are a part of the group.

The web-based tracing system 100 further comprises a communication module 118 for dispensing communication services comprising textual and audiovisual chats and sharing of files between individual users of the genealogy system and among users in a group in the genealogy system. The communication module 118 allows users to post information on their user accounts that can be viewed by other users of the genealogy system. The communication module 118 allows a user to edit or delete posted information, chat messages, or shared files that are created by that user.

The web-based tracing system 100 further comprises a notification module 120 for notifying users with accounts in a family tree of additions of accounts to the family tree or flagging of an account as belonging to a newborn or a deceased person by a user in the family tree after verification by administrative personnel of the genealogy system.

The web-based tracing system 100 further comprises an advertisement module 122 for dispensing advertisement services comprising posting and reacting to advertisements for goods and services in the genealogy system by users of the genealogy system. The advertisement module 122 allows highlighting advertisements and posted information of users based on priority criteria comprising payment for the highlighting and popularity of the advertisements, posted information, or the user creating the advertisement or posting the information.

The web-based tracing system 100 further comprises a commerce module 124 for handling one-time and recurring monetary transactions and storing and auditing financial and transactional information.

The web-based tracing system 100 further comprises a security module 126 for ensuring security of information, communication, and transactions in the genealogy system including encryption of data.

The web-based tracing system 100 further comprises a publishing module 128 for publishing reports and summaries comprising user information, family tree graphs, communication reports, and financial reports derived from data in the genealogy system.

The web-based tracing system 100 further comprises an administration module 130 for administering the genealogy system. Administration comprises creation, activation, blocking, and suspension of accounts in the genealogy system by administrative personnel of the genealogy system. The administrative personnel verify credibility of accounts, user-posted information, and advertisements, and receive, respond to, and act on complaints by users of the genealogy system. An account in the genealogy system is not deleted when suspended to retain structure of the family trees and descendent nodes of the account. The web-based tracing system 100 is hosted on a computer server 101 connected to a communication network 150, as shown in FIG. 1. The web-based tracing system 100 is available to users around the world on multiple computing devices including smartphones 104 and computers 106. The genealogy system can be extended by any user of the genealogy system to fit individual needs within administrative rules of the genealogy system.

As illustrated in FIG. 1, the web-based tracing system 100 for tracing genealogy and providing social and commercial networking services. The web-based tracing system 100 is hosted on the computer server 101 connected to the communication network 150, as shown in FIG. 1. In an embodiment, the computer server 100 is programmable using a high-level computer programming language. In an embodiment, the web-based tracing system 100 uses programmed and purposeful hardware. In an embodiment, the web-based tracing system 100 is implemented on a computing device, for example, a personal computer, a tablet computing device, a mobile computer, a portable computing device, a laptop, a touch centric device, a workstation, a client device, a portable electronic device, a network enabled computing device, an interactive network enabled communication device, any other suitable computing equipment, combinations of multiple pieces of computing equipment, etc. In the computer server 101 disclosed herein, the web-based tracing system 100 interfaces with an external database 152 for obtaining genealogical data.

The web-based tracing system 100 communicates with the external database 152 and the smartphones 104 and computers 106 of the users via the communication network 150, for example, a short-range network or a long-range network. The communication network 150 is, for example, one of the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. In an embodiment, the web-based tracing system 100 is accessible to users, for example, through a broad spectrum of technologies and devices such as personal computers, internet enabled cellular phones, tablet computing devices, etc., with access to the internet.

As exemplarily illustrated in FIG. 1, the web-based tracing system 100 comprises a non-transitory computer readable storage medium, for example, a memory unit 102 for storing programs and data, and at least one processor 134 communicatively coupled to the non-transitory computer readable storage medium. As used herein, “non-transitory computer readable storage medium” refers to all computer readable media, for example, non-volatile media, volatile media, and transmission media, except for a transitory, propagating signal. Non-volatile media comprise, for example, solid state drives, optical discs or magnetic disks, and other persistent memory volatile media including a dynamic random access memory (DRAM), which typically constitute a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to the processor 134. The non-transitory computer readable storage medium is configured to store computer program instructions defined by modules, for example, 114-130, etc., of the web-based tracing system 100. The modules, for example, 114-130, etc., of the web-based tracing system 100 are installed and stored in the memory unit 102 of the web-based tracing system 100. The memory unit 102 is used for storing program instructions, applications, and data. The memory unit 102 is, for example, a random access memory (RAM) or another type of dynamic storage device that stores information and instructions for execution by the processor 134. The memory unit 102 also stores temporary variables and other intermediate information used during execution of the instructions by the processor 134. The web-based tracing system 100 further comprises a read only memory (ROM) or another type of static storage device that stores static information and instructions for the processor 134.

The processor 134 is configured to execute the computer program instructions defined by the modules, for example, 114-130, etc., of the web-based tracing system 100. The processor 134 refers to any of one or more microprocessors, central processing unit (CPU) devices, finite state machines, computers, microcontrollers, digital signal processors, logic, a logic device, a user circuit, an application specific integrated circuit (ASIC), a field-programmable gate array (FPGA), a chip, etc., or any combination thereof, capable of executing computer programs or a series of commands, instructions, or state transitions. In an embodiment, the processor 134 is implemented as a processor set comprising, for example, a programmed microprocessor and a math or graphics co-processor. The processor 134 is selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines)(IBM® processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The web-based tracing system 100 disclosed herein is not limited to employing a processor 134. In an embodiment, the web-based tracing system 100 employs a controller or a microcontroller. The processor 134 executes the modules, for example, 114-130, etc., of the web-based tracing system 100.

As exemplarily illustrated in FIG. 1, the web-based tracing system 100 further comprises a display unit 136, a data bus 132, a network interface 138, an input/output (I/O) controller 140, input devices 142, a fixed media drive 144 such as a hard drive, a removable media drive 146 for receiving removable media, output devices 148, etc. The display unit 136, via the graphical user interface (GUI) 136a, displays information. The display unit 136 comprises, for example, a video display, a liquid crystal display, a plasma display, an organic light emitting diode (OLED) based display, etc. The display unit 136 displays the GUI 136a. The GUI 136a is, for example, one of a webpage of a website hosted by the web-based tracing system 100, an online web interface, a web based downloadable application interface, a mobile based downloadable application interface, etc. The GUI 136a allows a user, for example, an administrator of the web-based tracing system 100 to configure the web-based tracing system 100.

The data bus 132 permits communications between the modules, for example, 114-130, etc., of the web-based tracing system 100. The network interface 138 enables connection of the web-based tracing system 100 to the communication network 150. In an embodiment, the network interface 138 is provided as an interface card also referred to as a “line card”. The network interface 138 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 140 controls input actions and output actions performed by the web-based tracing system 100.

The input devices 142 are used to input data into the web-based tracing system 100 and for routine maintenance of the web-based tracing system 100. The user uses the input devices 142 to provide inputs to the web-based tracing system 100. The input devices 142 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc. The output devices 142 output the results of operations performed by web-based tracing system 100.

Functional requirements of the web-based tracing system 100 are illustrated in (a) to (m) below.

(a) Ability to add a relative to self: The user can create his account and then starts to add the relatives to himself. As he does so, he is literally creating accounts of those relatives on the web-based tracing system 100.

Initial account: This is an account created in the system for the first time. In this scenario, the email address that this person creates does not exist anywhere in the system. This account does not have a parent and therefore it's made the root node. However, a user can assign a parent to this account, depending on what the user wants to do with that account.

Pre-created account: These are accounts created by another account, for example when an initial account creates the descendants of him, those descendants will be made accounts as well, and these accounts are left in the pending status until the owner attempts to create an account, and instead they are made to simply activate that account. The user does not need to know that his account was already created, the system shall simply tell him to activate that account. After this account user successfully logs in, then they can see the families where they belong and the person that created that particular account. On creating this account, the user shall be notified that he has been assigned to a certain family in the web-based tracing system 100, in this email shall be a link that links the user to activate their account.

All accounts are stored in a tree data structure. An account that is not a descendant or is not an ancestor of any other account shall have limited functionalities. These single accounts shall only be able to run adverts, their posts shall stay visible to only them until they are converted to adverts. When an account is blocked, in the tree it will appear as a person icon with no information. Accounts shall not be deleted at all, because deleting an account is like deleting a note in the tree, and that would mean all the other accounts (descendants) shall be deleted. An account can be referenced in different family trees, this is because a person can be a son in one family and husband to some daughter (Son in law) in another family tree when this person is clicked on in a foreign reference, and the user shall be redirected to the original family.

(b) Ability to search a relative/person: a logged-in user shall type the name or an email address in the search area, all matches shall appear in the list. The user will then look through to identify which person they are looking for, on clicking this search result, a family tree of that person opens up.

(c) Ability to view the relatives that one has: Within the software, one can click on a person and then sees their relatives.

(d) Ability to communicate with the relative(s), this can be public or private

One to one chat: The user clicks (selects) another user (that belongs to his tree) from his family tree or any other tree. A new page opens up, this page has the full details of this account, and it shows the name, profile picture, and posts published by this user. Inside that account, you shall chat with that person. Chats shall be text, images, audio files, and video files. Inside the web, the user will simply upload these files, but inside the phone applications, the user shall be able to record an audio and send it instantly, take a picture and send it instantly. This message can be deleted, if deleted by the sender, then the receiver shall stop seeing that message, but if the receiver deletes it, then the sender can stay seeing that message, the sender shall not know that the receiver deleted that messages.

Group chats: A user shall create a group, this group shall have a name, a picture, and a description. After creating the group this user shall become the first person in that group, but for it to start operating it shall have 3 or more people, a group with less than three people shall not be activated. Messages shared in this group shall only be visible to those in the group. The same rules as those a one to one chat shall apply. The user that created the group shall add more users to this group. Every family member shall belong to a family group by default. The group name of this group shall be edited by any group members. Group chats shall also be customizable to assist with family planning for annual events such as family reunions. Chats can also be used to communicate one-time events such as weddings, funerals, or graduations.

(e) Ability to send a notification: For example, when a new person is added on self-tree or when a person is labeled as deceased or newborn, the relatives shall get a notification when that person added or set to dead. This notification shall be inside the system as well as an email sent to the users in that same lineage. Notifications can also include birthdays and wedding anniversaries with the ability to opt in or out of these updates.

(f) Ability to upload short media files: The system shall be able to upload media files. In this version, we shall support videos, audios, pictures, word, excel, and PDF files. This system will serve as an interactive tool for preserving family histories by documenting oral stories that can be recorded, saved, and stored for future generations. Pictures can be labeled to assist in maintaining family knowledge regarding ancestors in photos.

(g) Ability to view all self-relatives and their relationship: A person shall have the ability to see his descendants, siblings, ancestors, and relatives, this shall be done in a hierarchical graph as well as a list.

(h) Ability to remove a relative or update a relative/or personal information if added by self: In case a person was added to a family in error, there should be an ability to remove (if no children) that person or update (if has children) them.

(i) Ability to post advertisements and monitoring there visibility: The user can post information for public or selected people or linage members to see and react to it. This post shall contain the text and some media files (optional).

(j) Ability to collect money/subscriptions for those that are advertising: This user shall have the ability to add a subscription plan to his post so that it can be boosted as an advertisement. The system shall use PayPal or Flutter wave to collect money from these users for these subscriptions.

(k) Ability to load fast, better website performance: The website and the phone application shall be fast at loading and rendering data so that the end-user has a better experience while navigating through the software.

(l) Ability to transfer data in a secure way: Using the let's encrypt, the system shall be able to transfer data in an encrypted and secure way.

(m) User roles and policies: The system shall enable the users to have different user roles, as explained below in (a)-(c):
a) System administrato-
   Can create other employees on the platfor-
   Can create advertisement plan-
   Can view data in a summarized format (Reports-
   Can block/suspend a user account
b) Employe-
   Can activate or suspend user account-
   Can respond to user complaint-
   Can view posts to verify the credibility
c) Custome-
   Can create an accoun-
   Can add people to the linag-
   Can post article-
   Can boost article-
   Can raise a complain-
   Can chart with people through personal or group chat-
   Can also see reports about his accoun-
   Can view his relatives in the Linage

Interface requirements of the web-based tracing system 100 are illustrated in (a) to (c) below.

Graphical User Interface: The interactive User Interface shall be written in XML (for mobile applications), HTML and JavaScript and CSS for the Web application.

Command line interface: At deployment of the software and publishing new versions, a command-line software like Putty shall be used to access the remote deployment server. This is only used by the person responsible for the maintenance and deployment of source code to the live server.

API: The Application Programming Interface (API) shall be served by the back end (server-side) application to feed the mobile applications with data that is required to do what the web application does.

Performance requirements of the web-based tracing system 100 are illustrated below.

The software application 108 shall run on the web browser, iPhone, or Android. The server specification on which the application shall run are as follows:

| | | |
|---|---|---|
| Memory (RAM) | 4 | GB |
| Virtual CPUs | 2 | vCPUs |
| Data transfer limit | 4 | TB |
| SSD (Disk Space) | 80 | GB |

In an embodiment, the performance requirements are scalable, for example, by increasing the volumes.

Other non-functional attributed of the web-based tracing system 100 are illustrated in (a)-(g) below.

(a) Security: The system shall be designed with a level of security appropriate for the sensitivity of information enclosed in the database. More interaction is needed with the client about the volatility of the information. Since there is no obvious information that is of a high-security level such as credit card information, the only requirements that could be implemented are encrypting the database and/or making the database password-protected, by the user's request.

(b) Binary Compatibility: This system will be compatible with any computer operating system and all current phones on the market apart from the windows phone. Windows users will access the system through the browser on that phone.

(c) Reliability: Reliability is one of the key attributes of the system. Back-ups will be made regularly so that restoration with minimal data loss is possible in the event of unforeseen events. The system will also be thoroughly tested by all team members to ensure reliability.

(d) Maintainability: The system shall be maintained by the development team.

(e) Extensibility: The system shall be designed and documented in such a way that anybody with an understanding of computers shall be able to extend the system to fit their intended needs with or without the team's basic instructions.

(f) Reusability: The system should be designed in a way that allows the database to be re-used regularly for the various silent auctions that the organization shall hold. So that it's easy for the new systems in the company to reuse some of its functions.

(g) Serviceability: The maintenance of the system should be able to be sufficiently performed by any person with a basic understanding of Laravel, Android, Swift, JavaScript and Ubuntu (Apache2).

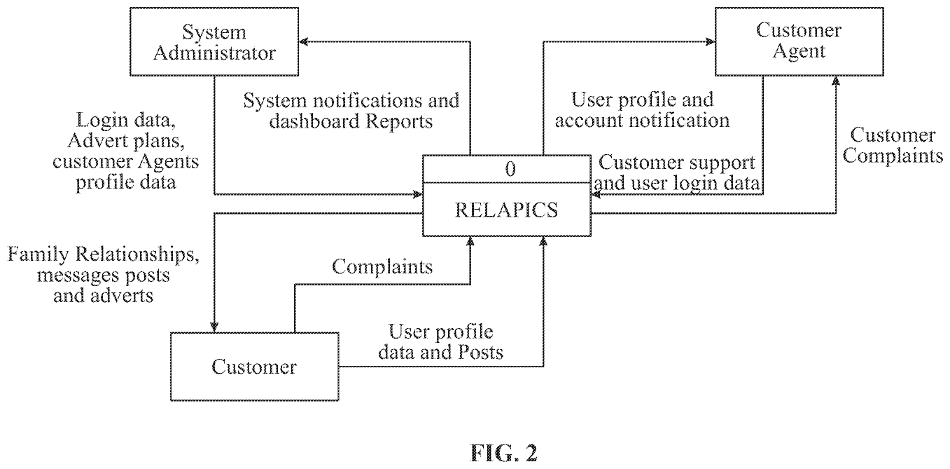

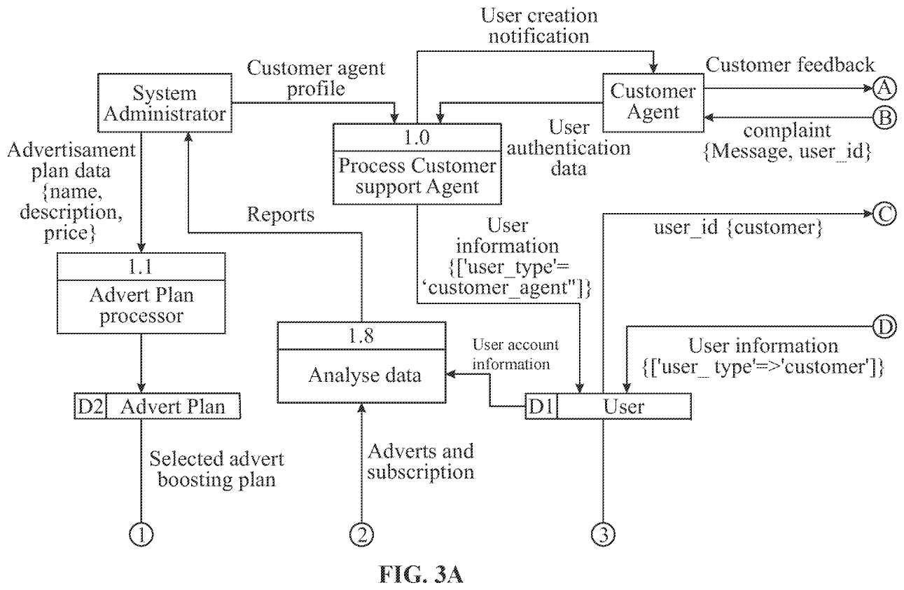

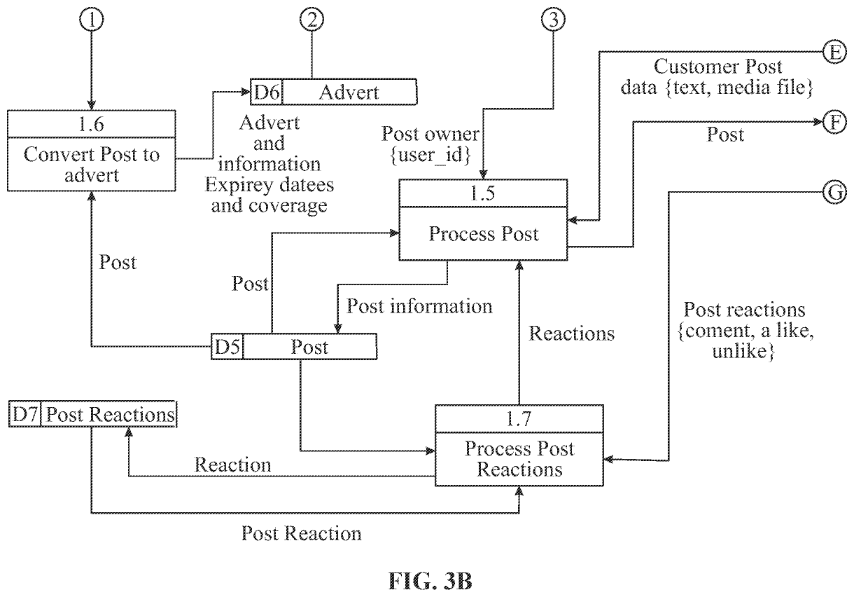

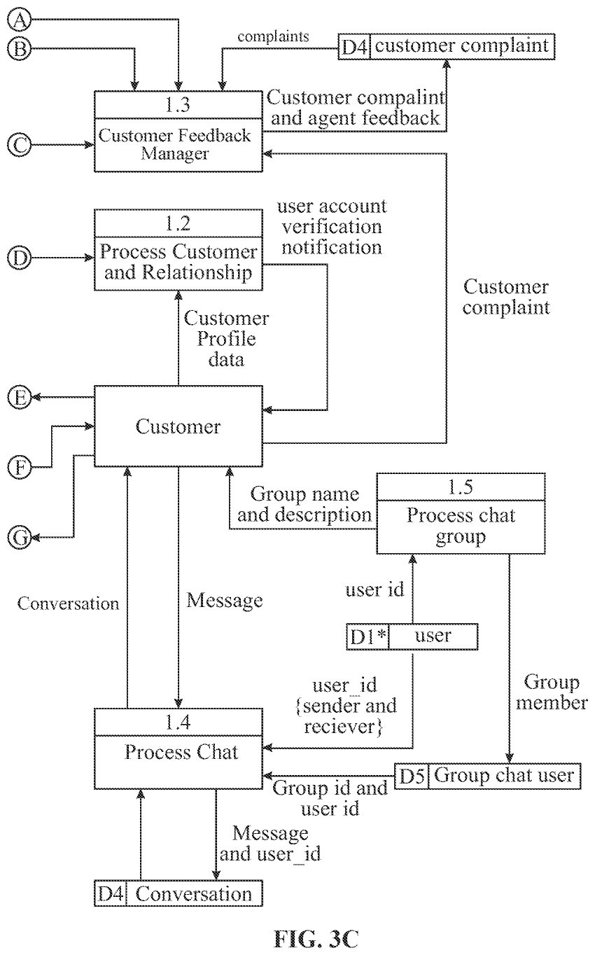

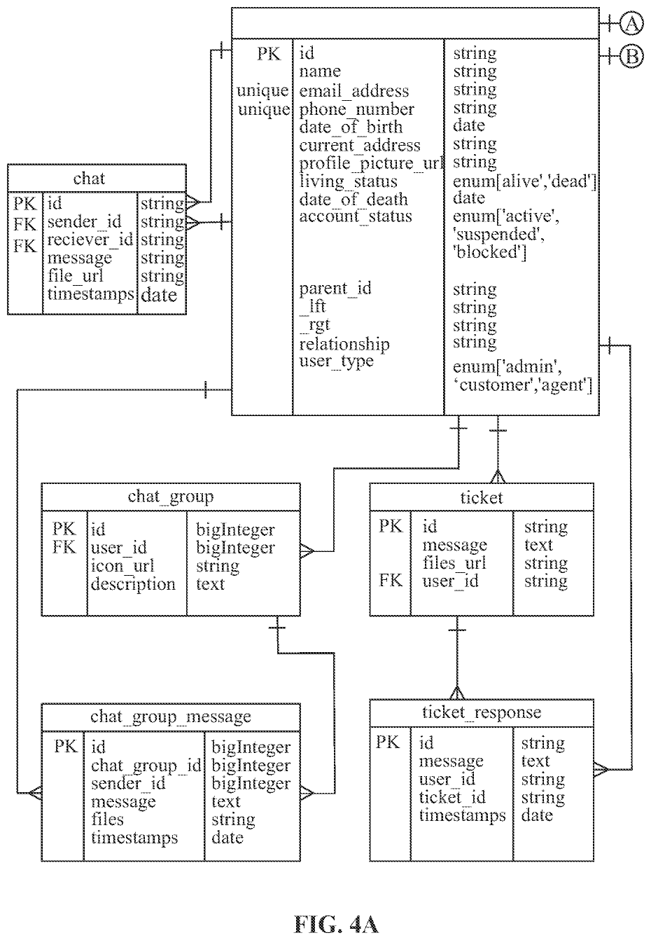

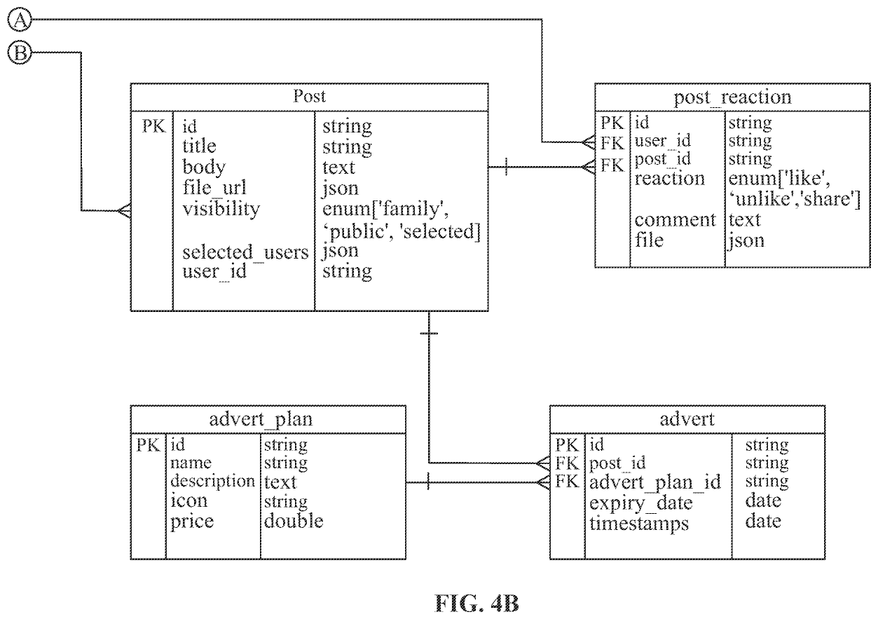

FIGS. 2 and 3A-3C illustrate fundamental data flow diagrams and the Entity relation diagram that satisfy the system's requirements. FIG. 2 illustrates a context diagram for the web-based tracing system 100. FIGS. 3A-3C illustrate a data flow diagram of the web-based tracing system 100. FIGS. 4A-4B illustrate an entity relation diagram of the web-based tracing system 100.

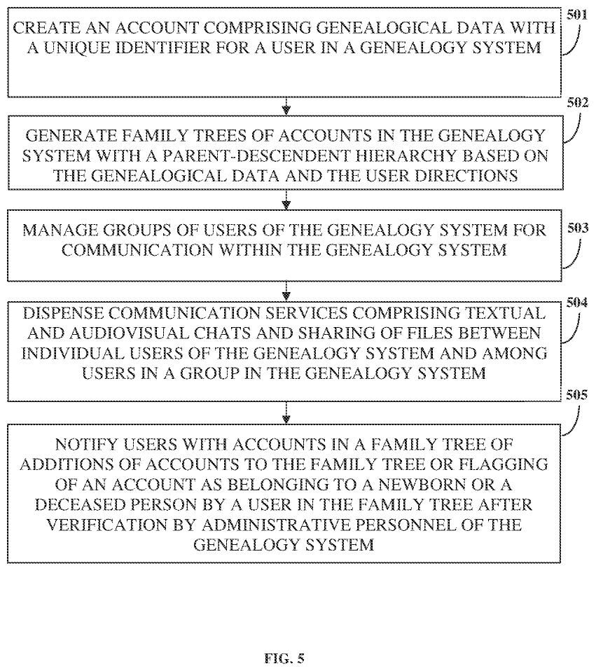

FIG. 5 exemplarily illustrates a computer implemented method for web-based tracing. The method comprises creating 501 an account comprising genealogical data with a unique identifier for a user in a genealogy system, generating 502 family trees of accounts in the genealogy system with a parent-descendent hierarchy based on the genealogical data and the user directions, managing 503 groups of users of the genealogy system for communication within the genealogy system, dispensing 504 communication services comprising textual and audiovisual chats and sharing of files between individual users of the genealogy system and among users in a group in the genealogy system, and notifying 504 users with accounts in a family tree of additions of accounts to the family tree or flagging of an account as belonging to a newborn or a deceased person by a user in the family tree after verification by administrative personnel of the genealogy system. The method further comprises dispensing advertisement services comprising posting and reacting to advertisements for goods and services in the genealogy system by users of the genealogy system, handling one-time and recurring monetary transactions and storing and auditing financial and transactional information, ensuring security of information, communication, and transactions in the genealogy system including encryption of data, publishing reports and summaries comprising user information, family tree graphs, communication reports, and financial reports derived from data in the genealogy system; and administering the genealogy system.

### Definitions

Lineage: A lineage is a unilineal descent group that can demonstrate their common descent from a known apical ancestor. Unilineal lineages can be matrilineal or patrilineal, depending on whether they are traced through mothers or fathers, respectively.

A constraint: is a restriction on the degree of freedom you have in providing a solution. Constraints are effectively global requirements, such as limited development resources or a decision by senior management that restricts the way you develop a system.

An application programming interface (API) is a computing interface that defines interactions between multiple software intermediaries. It defines the kinds of calls or requests that can be made, how to make them, the data formats that should be used, and the conventions to follow.

Main components or tasks involved in the web-based tracing system 100 are as follows:

Opening accounts: When a user is created in the system that becomes an account. This account can be pending activation, active, suspended, or closed.

How Accounts are Created

Initial account: This is an account created in the system for the first time. In this scenario, the email address that this person creates does not exist anywhere in the system. This account does not have a parent and therefore it's made the root node. However, a user can assign a parent to this account, depending on what the user wants to do with that account.

Pre-created account: These are accounts created by another account, for example when an Initial account creates the descendants of him, those descendants will be made accounts as well, and these accounts are left in the pending status until the owner attempts to create an account, and instead they are made to simply activate that account. The user does not need to know that his account was already created, the system shall simply tell him to activate that account. After this account successfully logs in, then they can see the families where they belong and the person that created that particular account. On creating this account, the user shall be notified that he has been assigned to a certain family in the web-based tracing system 100, in this email shall be a link that links the user to activate their account.

All accounts are stored in a tree data structure. An account that is not a descendant or is not an ancestor of any other account shall have limited functionalities. These single accounts shall only be able to run adverts, their posts shall stay visible to only them until they are converted to adverts.

When an account is blocked, in the tree it will appear as a person icon with no information. Accounts shall not be deleted at all, because deleting an account is like deleting a note in the tree, and that would mean all the other accounts (descendants) shall be deleted.

An account can be referenced in different family trees, this is because a person can be a son in one family and husband to some daughter (Son in law) in another family tree, when this person is clicked on in a foreign reference, and the user shall be redirected to the original family.

Searching a User

A logged-in user shall type the name or an email address in the search area, all marches shall appear in the list. The user will then look through to identify which person they are looking for, on clicking this search result, a family tree of that person opens up.

Communications and Chats: As explained above, users have the ability to communicate and/or chat with their relative(s) using either the one to one chat or the Group chat. The chats and communications can be made public or kept private.

Posts: A post is an article, for example when a user wants to communicate a message to the public, family, or selected individuals, they shall write this information and then choose its audience. This information shall include a title and the body. The user may choose to add a media file, for example, a picture, audio, or a video file. By default this post is in pending status, it can be published, suspended (by an agent) or closed.

Post Reactions: Users can react on a post, for example, they can comment, like it or unlike it, they shall also be able to share that post with other social media applications that exist for example Facebook, Twitter and WhatsApp. The users that are commenting on a post shall have the ability to add media files.

Advertisements: An advert is a post that has been boosted (paying a subscription plan for a post). The user shall post content as a post, and then they shall add a subscription plan to this post.

A subscription plan: This is the amount of money that the person can choose to pay in order to boost their post. For example, there can be a plan that targets 500 to 1,000 users for 5 USD in one week, there can be another plan that targets 10,000 users in a particular geographical area for 25 USD in one month, the users to which this post is distributed to shall be users of the system. The owner of the advert can be monitoring their posts, he can see who has liked or disliked his post, and he can see the period left for the subscription plan to expire.

The system administrators: This type of user is the overall use of the system, this user can view any user with their profile information, he shall have the ability to view what other users post, and he shall have the ability to block posts, and suspend and unsuspend accounts. Suspended accounts cannot log in into the system but they stay visible in their family trees. This user can view posts and adverts that have been boosted, he can create adverts on behalf of other users, he can open accounts on behalf of other users, and he shall be able to view the money transactions through the subscription plan, and a dashboard that will summarize the data in the entire system shall be accessed by this user. This user shall have the ability to create agents

Agents: this user is responsible for customer care when customers have questions, this user will be responsible for responding to them. This user shall also have the ability to monitor the content in the posts of the users, and he can suspend a user's account.

It is apparent in different embodiments that the various methods, algorithms, and computer programs disclosed herein are implemented on non-transitory computer readable storage media appropriately programmed for computing devices. The non-transitory computer readable storage media participate in providing data, for example, instructions that are read by a computer, a processor or a similar device. In different embodiments, the “non-transitory computer readable storage media” also refer to a single medium or multiple media, for example, a centralized database, a distributed database, and/or associated caches and servers that store one or more sets of instructions that are read by a computer, a processor or a similar device. The “non-transitory computer readable storage media” also refer to any medium capable of storing or encoding a set of instructions for execution by a computer, a processor or a similar device and that causes a computer, a processor or a similar device to perform any one or more of the methods disclosed herein. Common forms of the non-transitory computer readable storage media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

In an embodiment, the computer programs that implement the methods and algorithms disclosed herein are stored and transmitted using a variety of media, for example, the computer readable media in various manners. In an embodiment, hard-wired circuitry or custom hardware is used in place of, or in combination with, software instructions for implementing the processes of various embodiments. Therefore, the embodiments are not limited to any specific combination of hardware and software. The computer program codes comprising computer executable instructions can be implemented in any programming language. Examples of programming languages that can be used comprise C, C++, C #, Java®, JavaScript®, Fortran, Ruby, Perl®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, various aspects of the method and the web-based tracing system 100 disclosed herein are implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. In another embodiment, various aspects of the method and the web-based tracing system 100 disclosed herein are implemented as programmed elements, or non-programmed elements, or any suitable combination thereof.

Where databases are described such as the external database 152 and the genealogical database 112, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. Object methods or behaviors of a database can be used to implement various processes such as those disclosed herein. In another embodiment, the databases are, in a known manner, stored locally or remotely from a device that accesses data in such a database. In embodiments where there are multiple databases in the web-based tracing system 100, the databases are integrated to communicate with each other for enabling simultaneous updates of data linked across the databases, when there are any updates to the data in one of the databases.

The method and the web-based tracing system 100 disclosed herein can be configured to work in a network environment comprising one or more computers that are in communication with one or more devices via a network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, examples of which are disclosed above. While the operating system may differ depending on the type of computer, the operating system provides the appropriate communications protocols to establish communication links with the network. Any number and type of machines may be in communication with the computers.

The method and the web-based tracing system 100 disclosed herein are not limited to a particular computer system platform, processor, operating system, or network. In an embodiment, one or more aspects of the method and the web-based tracing system 100 disclosed herein are distributed among one or more computer systems, for example, servers configured to provide one or more services to one or more client computers, or to perform a complete task in a distributed system. For example, one or more aspects of the method and the web-based tracing system 100 disclosed herein are performed on a client-server system that comprises components distributed among one or more server systems that perform multiple functions according to various embodiments. These components comprise, for example, executable, intermediate, or interpreted code, which communicate over a network using a communication protocol. The method and the web-based tracing system 100 disclosed herein are not limited to be executable on any particular system or group of systems, and are not limited to any particular distributed architecture, network, or communication protocol.

The foregoing examples have been provided merely for explanation and are in no way to be construed as limiting of the method and the web-based tracing system 100 disclosed herein. While the method and web-based tracing system 100 have been described with reference to various embodiments, it is understood that the words, which have been used herein, are words of description and illustration, rather than words of limitation. Furthermore, although the method and the web-based tracing system 100 have been described herein with reference to particular means, materials, and embodiments, the method and the web-based tracing system 100 are not intended to be limited to the particulars disclosed herein; rather, the method and the web-based tracing system 100 extend to all functionally equivalent structures, methods and uses, such as are within the scope of the appended claims. While multiple embodiments are disclosed, it will be understood by those skilled in the art, having the benefit of the teachings of this specification, that the method and the web-based tracing system 100 disclosed herein are capable of modifications and other embodiments may be effected and changes may be made thereto, without departing from the scope and spirit of the method and the web-based tracing system 100 disclosed herein.

1: A web-based tracing system, comprising:
an account creation module for creating an account comprising genealogical data with a unique identifier for a user in a genealogy system;
a genealogy module for generating family trees of accounts in the genealogy system with a parent-descendent hierarchy based on the genealogical data and the user directions;
a group moderation module for managing groups of users of the genealogy system for communication within the genealogy system;
a communication module for dispensing communication services comprising textual and audiovisual chats and sharing of files between individual users of the genealogy system and among users in a group in the genealogy system; and
a notification module for notifying users with accounts in a family tree of additions of accounts to the family tree or flagging of an account as belonging to a newborn or a deceased person by a user in the family tree after verification by administrative personnel of the genealogy system.

2: The web-based tracing system of claim 1 further comprises:
an advertisement module for dispensing advertisement services comprising posting and reacting to advertisements for goods and services in the genealogy system by users of the genealogy system;
a commerce module for handling one-time and recurring monetary transactions and storing and auditing financial and transactional information;
a security module for ensuring security of information, communication, and transactions in the genealogy system including encryption of data;
a publishing module for publishing reports and summaries comprising user information, family tree graphs, communication reports, and financial reports derived from data in the genealogy system; and
an administration module for administering the genealogy system.

3: A computer implemented method for web-based tracing, comprising:
creating an account comprising genealogical data with a unique identifier for a user in a genealogy system;
generating family trees of accounts in the genealogy system with a parent-descendent hierarchy based on the genealogical data and the user directions;
managing groups of users of the genealogy system for communication within the genealogy system;
dispensing communication services comprising textual and audiovisual chats and sharing of files between individual users of the genealogy system and among users in a group in the genealogy system; and
notifying users with accounts in a family tree of additions of accounts to the family tree or flagging of an account as belonging to a newborn or a deceased person by a user in the family tree after verification by administrative personnel of the genealogy system.

4: The method of claim 3, further comprising:
dispensing advertisement services comprising posting and reacting to advertisements for goods and services in the genealogy system by users of the genealogy system;
handling one-time and recurring monetary transactions and storing and auditing financial and transactional information;
ensuring security of information, communication, and transactions in the genealogy system including encryption of data;
publishing reports and summaries comprising user information, family tree graphs, communication reports, and financial reports derived from data in the genealogy system; and
administering the genealogy system.

5: A non-transitory computer readable storage medium having embodied thereon, computer program codes comprising instructions executable by at least one processor of a web-based tracing system for tracing genealogy and providing social and commercial networking services, wherein the computer program codes comprise:
a first computer program code for creating an account comprising genealogical data with a unique identifier for a user in a genealogy system;
a second computer program code for generating family trees of accounts in the genealogy system with a parent-descendent hierarchy based on the genealogical data and the user directions;
a third computer program code for managing groups of users of the genealogy system for communication within the genealogy system;
a fourth computer program code for dispensing communication services comprising textual and audiovisual chats and sharing of files between individual users of the genealogy system and among users in a group in the genealogy system; and
a fifth computer program code for notifying users with accounts in a family tree of additions of accounts to the family tree or flagging of an account as belonging to a newborn or a deceased person by a user in the family tree after verification by administrative personnel of the genealogy system.

6: The non-transitory computer readable storage medium of claim 5, further comprising:
a sixth computer program code for dispensing advertisement services comprising posting and reacting to advertisements for goods and services in the genealogy system by users of the genealogy system;
a seventh computer program code for handling one-time and recurring monetary transactions and storing and auditing financial and transactional information;
an eighth computer program code for ensuring security of information, communication, and transactions in the genealogy system including encryption of data;
a ninth computer program code for publishing reports and summaries comprising user information, family tree graphs, communication reports, and financial reports derived from data in the genealogy system; and
a tenth computer program code for administering the genealogy system.
